(19) United States
(12) Patent Application Publication
(10) Pub. No.: US 2025/0200026 A1
(43) Pub. Date: Jun. 19, 2025

(54) SYSTEM AND METHOD FOR AI-BASED GRAPH MANAGEMENT

(71) Applicants: David Winer, Alexandria, VA (US); Zhengyuan Wang, Hoboken, NJ (US); Jia Wang, San Francisco, CA (US)

(72) Inventors: David Winer, Alexandria, VA (US); Zhengyuan Wang, Hoboken, NJ (US); Jia Wang, San Francisco, CA (US)

(21) Appl. No.: 18/545,346

(22) Filed: Dec. 19, 2023

(51) Int. Cl. G06F 16/24; G06F 40/205

(52) U.S. Cl. CPC G06F 16/24; G06F 40/205

(57) ABSTRACT

A system for an automated real-time management of a directed acyclic graph (DAG) based on predictive analytics of DAG input-related data including a processor of a graph compute manager (GCM) node configured to host a machine learning (ML) module and connected to at least one DAG source entity node over a network and a memory on which are stored machine-readable instructions that when executed by the processor, cause the processor to: acquire the DAG input-related data from the at least one DAG source entity node; parse the DAG input-related data to derive a plurality of key features; query a local DAGs' database to retrieve local historical DAGs'-related data associated with previous DAG parameters based on the plurality of key features; generate at least one feature vector based on the plurality of key features and the local historical DAGs'-related data; and provide the at least one feature vector to the ML module for generating a predictive model configured to produce at least one DAG update parameter for updating the DAG at the at least one DAG source entity.

### FIELD OF DISCLOSURE

The present disclosure generally relates to automated management of a directed acyclic graph (DAG), and more particularly, to an AI-based automated system for real-time management of the DAG based on predictive analytics of DAG input-related data.

### BACKGROUND

The process of building a graph for projects and application development is commonly used in software product development. In particular, Directed Acyclic Graph (DAGs) are commonly used. A DAG is a conceptual representation of a series of activities, or, in other words, a mathematical abstraction of a data pipeline. In a nutshell, a DAG defines a sequence of execution stages in any non-recurring algorithm.

Manually building workflow code challenges the productivity of engineers, which is one reason there are a lot of helpful tools out there for automating the process. A great first step to efficient automation is to realize that DAGs can be an optimal solution for moving data in nearly every computing-related area. However, manual management of the DAG may be inefficient in cases of complex software development workflows. Conventional DAG-based systems rely solely on manual user inputs, which is inefficient for software development projects.

Accordingly, an AI-based automated system and method for real-time management of DAGs based on predictive analytics of DAG input-related data are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for an automated real-time management of a directed acyclic graph (DAG) based on predictive analytics of DAG input-related data including a processor of a graph compute manager (GCM) node configured to host a machine learning (ML) module and connected to at least one DAG source entity node over a network and a memory on which are stored machine-readable instructions that when executed by the processor, cause the processor to: acquire the DAG input-related data from the at least one DAG source entity node; parse the DAG input-related data to derive a plurality of key features; query a local DAGs' database to retrieve local historical DAGs'-related data associated with previous DAG parameters based on the plurality of key features; generate at least one feature vector based on the plurality of key features and the local historical DAGs'-related data; and provide the at least one feature vector to the ML module for generating a predictive model configured to produce at least one DAG update parameter for updating the DAG at the at least one DAG source entity.

Another embodiment of the present disclosure provides a method that includes one or more of: acquiring, by a graph compute manager (GCM) node, the DAG input-related data from at least one DAG source entity node; parsing, by the GCM node, the DAG input-related data to derive a plurality of key features; querying, by the GCM node, a local DAGs' database to retrieve local historical DAGs'-related data associated with previous DAG parameters based on the plurality of key features; generating, by the GCM node, at least one feature vector based on the plurality of key features and the local historical DAGs'-related data; and providing, by the GCM node, the at least one feature vector to the ML module for generating a predictive model configured to produce at least one DAG update parameter for updating the DAG at the at least one DAG source entity.

Another embodiment of the present disclosure provides a computer-readable medium including instructions for acquiring the DAG input-related data from at least one DAG source entity node; parsing the DAG input-related data to derive a plurality of key features; querying a local DAGs' database to retrieve local historical DAGs'-related data associated with previous DAG parameters based on the plurality of key features; generating at least one feature vector based on the plurality of key features and the local historical DAGs'-related data; and providing the at least one feature vector to the ML module for generating a predictive model configured to produce at least one DAG update parameter for updating the DAG at the at least one DAG source entity.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of a system for an automated real-time DAG management based on predictive analytics of DAG input-related data consistent with the present disclosure.

FIG. 1B illustrates a network diagram of a system for an automated real-time DAG management based on predictive analytics of DAG input-related data employing a blockchain consistent with the present disclosure;

FIG. 2 illustrates a network diagram of a system including detailed features of a graph compute manager (GCM) node consistent with the present disclosure;

FIG. 3A illustrates a flowchart of a method for an automated real-time DAG management based on predictive analytics of DAG input-related data consistent with the present disclosure;

FIG. 3B illustrates a further flowchart of a method for an automated real-time DAG management based on predictive analytics of DAG input-related data consistent with the present disclosure;

FIG. 4 illustrates deployment of a machine learning model for DAG management recommendation parameters using blockchain assets consistent with the present disclosure;

FIG. 5 illustrates a block diagram of a system including a computing device for performing the method of FIGS. 3A and 3B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of lead-based recommendations, embodiments of the present disclosure are not limited to use only in this context.

The present disclosure provides a system, method and computer-readable medium for an automated real-time DAG management based on predictive analytics of DAG input-related data. In one embodiment, the system overcomes the limitations of existing DAG management methods by employing fine-tuned machine learning models configured to generate DAG management parameters that may be used for automated DAG management. By leveraging the capabilities of the AI and machine learning, the disclosed approach offers a significant improvement over existing solutions discussed above in the background section.

In one embodiment of the present disclosure, the system provides for AI and machine learning (ML)-generated parameters based on analysis of DAG-related data. In one embodiment, the proposed system functions as a universal DAG management tool based on real-time demands and pre-defined parameters that may be provided by the AI/ML models.

The disclosed embodiments may be platform agnostic. The disclosed system, advantageously, seamlessly integrates with a multitude development tools, enabling users to manage applications through a singular DAG-based interface.

In one embodiment, an automated DAG management prediction model may be generated to provide for the DAG management parameters associated with a current DAG based on the current DAG-related data. The automated DAG management prediction model may use historical DAGs' data collected at the current development location and at third-party DAGs of the same type located within the same development network or even located globally. The relevant DAGs' data may include data related to other DAG source entities having the same parameters.

In one disclosed embodiment, the AI/ML technology may be combined with a blockchain technology for secure use of the DAG-related data and project development-related data. A blockchain consensus mechanism may be implemented where multiple nodes or instances of the system validate the DAGs for a particular built. This approach not only provides an additional layer of verification, but also reduces dependency on local data bases.

In one embodiment, the developer entities may be connected to the graph compute manager GCM node (or may be implemented on the GCM node) over a blockchain network to achieve a consensus prior to executing a transaction to release the DAG update decision data for the DAG based on the DAG update parameters produced by the AI/ML module.

In one embodiment, the DAG update recommendations may be produced directly on a granular level based on DAG input-associated digital data according to the AI-based predictive analysis and the DAG processing/orchestration recommendations (based on predictive DAG update parameters). This process includes a transparent recommendations/verdicts mechanism that may be coupled with a secure communications chat channel (implemented over a blockchain network) which supports all clients of the DAG management service. In one embodiment, the secure chat channel may be implemented using a chat Bot.

According to the disclosed embodiments, a program consisting of a plurality of functions is represented as a directed acyclic graph (DAG). The graph nodes are variables that are placeholders for data occupying an input of a function or an output of a function. The variables may be assigned a data type (e.g., integer, decimal, Boolean, text, etc.) and a data shape such as scalar, 1-dimensional, n-dimensional, (e.g., [32, 768] corresponds to a data shape that is 32 in the 0th dimension and 768 lengths in the 1st dimension). The variables can either be assigned data directly, or can be assigned a “reference_ID” that can be used to lookup the data from a source.

A graph edge (i.e., source, sink) is placed between variables, typically, from the output of a function to the input of another function. A variable is considered supplied when either it is a sink of a graph edge whose source is supplied or it has data assigned (either directly or via reference ID). A function is considered supplied at time T just when its inputs are supplied at time T. In the disclosed embodiments, functions are operations that run instructions of the program. Each function has a function type and each function type is associated with a plurality of preconditions (i.e., assertions, that are themselves Boolean functions) whose terms are the variables of the function.

The functions may be either primitive or composite. A primitive function runs directly. A composite function decomposes into a sub-graph. The sub-graph has an input variable for each input of the parent function, and an output variable for each output of the parent function. There is a graph edge from the input of the parent to the input of the sub-graph, and an output from the sub-graph output to the corresponding parent output. An edge that goes from a parent to a sub-graph (or vice versa) is referred to as a decompositional graph edge. Every sub-graph that can be formed without traversing a decompositional edge is called a graph level. The inputs and outputs of a function are always at the same graph level, so the functions of a graph level refer to the functions whose input and output variables are on the same graph level.

In one embodiment, a DAG may be connected to a deep learning module which may provide one or more changes to its state, and a DAG state manager tracks which variables have data supplied. The DAG state manager entity may have a set of global constants—i.e., data that can be directly assigned to many variables at once. Given a change to the state from a candidate set, the detector of the state manager entity determines, if an action to update is triggered, which data is supplied (or needs to be supplied) to perform the update. Every edit to the DAG may be submitted to the detector module. The detector module either composes a request to the graph compute manager to run functions, or clears the data if it needs to be cleared based on the action to update. If the data needs to be cleared, the resulting variables are transformed into a representation that can be consumed by the DAG graph compute manager to update the variables that are now unsupplied with data according to the presence of a reference ID corresponding to update/state changes.

If there are functions that need to be run, the request composer algorithm may produce a set of functions representing the minimal set of functions needed to complete the deep learning program as far as possible with respect to having no errors in the functions and such that no function is re-run if its inputs have not changed. The graph compute manager may implement a data service to coordinate retrieving data from reference IDs and to store all newly created reference IDs by writing to a local database or by recording onto a blockchain. The machine learning ML/AI module may also run functions that are related to reading and writing to object storage as well, which may at the time be optionally associated with a reference ID.

The graph compute manager produces a response that is transformed into a representation which can be consumed by the DAG state manager to update which variables are supplied with data according to the presence of a reference ID for that variable. The DAG may change its state (add edge, remove node, etc.) based on a plurality of possible occurrences/inputs such as, but not limited to, a DAG user interface input, user editing text-based code, external triggers from sensors or peripheral devices, from other server-side interactions, or autonomous decisions from an ML/AI module agent.

The detector module may receive one or more (potentially streaming) changes to the state of the DAG and determines how to update the DAG using deep learning program. Some conjunction of state changes may be aggregated into a single state change depending on how and when they are received. Among various possible actions, two main actions use cases can be taken per state change:

Action A (Composing Request) occurs when either:
1. The DAG has data supplied directly to an input variable that was previously not supplied.
2. An edge is added to the graph.
3. A new function is added to the DAG where the input variables are supplied.

Action B (Variable Clearing) occurs when either:
1. Data that is directly assigned to an input variable is removed.
2. An edge is removed from the graph.
3. A function is removed from the DAG.

After the detector module determines that an update request needs to be composed (Action A), the request composer module generates a function that needs to be run. Given an input variable that is newly supplied with data, the request composer algorithm formulates a sub-graph of the original DAG that tracks which functions that were not previously supplied would be supplied once all the previous functions in the sub-graph are supplied. In other words, the sub-graph contains just the functions that are not supplied before the edit and would be supplied if all the functions before it in the sub-graph are run to completion.

After each request, the request composer algorithm is run using the DAG as follows.

When a data is supplied directly to an input variable, or an edge is added and the source of the edge is the input:
Let the newly supplied input be called the “bootstrapped input”, and the function with the bootstrapped input is called bootstrapped function;
If it is an edge that is being added, then the reference ID is passed from the source to the sink of the edge.

Initially:
The bootstrapped variable is added to a set called the “execution path” (initially empty).
Another set of variables is denoted as “supplied” and also initially empty.
All edge sinks, recursively, originating from the bootstrapped input are added to the execution path. In this case, there may be decompositional edges from the bootstrapped input and from the decompositional edge sink, there could be more edges. Input variables of primitive functions have no outgoing edge.
All other inputs of the bootstrapped function that already have data supplied are added to the supplied set. Recursively, add all edge sinks to the supplied set.
Iteratively visit functions, starting with the bootstrapped function.

Decide:
If the function should be included in the request;
If it is a primitive function, all its inputs must either be supplied or be on the execution path.
If it is a composite function, then at least one input must be on the execution path.

Propagate:
If the function is primitive, all outgoing edge sinks from output variables are added to the execution path, recursively.
If the function is composite, then within the total order of functions of the sub-graph, visit the first function.

There are three kinds of composite functions:
Regular (“Composite”). A composite function has a sub-graph. There are no direct graph edges between a sub-graph input and a sub-graph output.
Conditional. A conditional function has a oolean input variable and two sub-graphs. The Boolean input determines which sub-graph to run.

The request composer iterates through both sub-graphs using loop. A loop operation has 0 or more sub-graph inputs and one or more outputs that are not part of the parent function inputs and outputs. One sub-graph output is a Boolean scalar variable that determines whether the function runs another iteration. The other extra sub-graph inputs are “looping” data, that on each subsequent iteration, take the value of the output sub-graph output with the same name.

Within the total ordering of functions at the same graph level as the current function, visit the next function. If there are no more functions to visit, then return.

Variable clearing may be implemented as follows. After the detector module determines that one or more variables need to be cleared (Action B), the variable clearer module makes updates. If data is removed from an input variable, or the graph edge that is removed was supplying the input, then an algorithm is run to determine which variables need “reference_IDs” removed to indicate they are no longer supplied in the program. A new graph edge type is introduced called a function dependency edge. For each primitive function, an edge is added from each input to each output. Then, the graph is traversed starting from the affected input variable. The graph traversal method can be standard, like Breadth First Search (BFS) or Depth First Search (DFS). Whenever an edge is visited, if the edge sink has a reference ID, it is removed.

In one embodiment, the Graph Compute Manager (GCM) receives one or more compute requests, and outputs one or more responses. Each request is a function, and each response is a function that includes “reference IDs” for each output that has data populated.

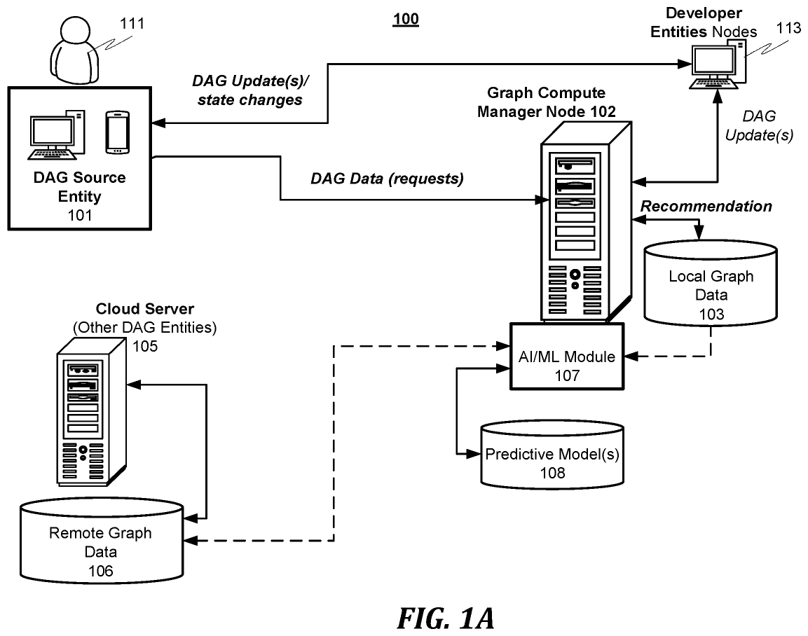

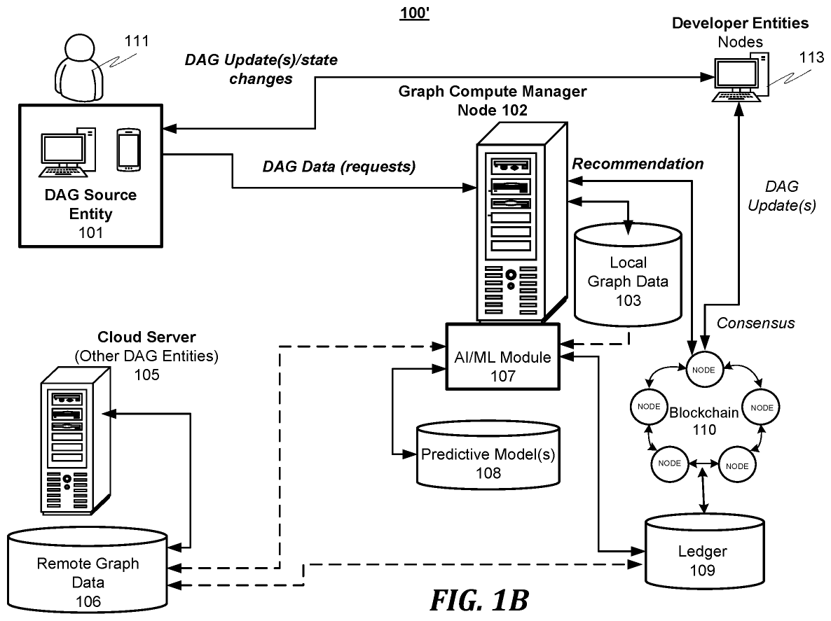

FIG. 1A illustrates a network diagram of a system for an automated real-time DAG management based on predictive analytics of DAG input-related data consistent with the present disclosure.

Referring to FIG. 1A, the example network 100 includes the Graph Compute Manager (GCM) node 102 connected to a cloud server node(s) 105 over a network. The GCM node 102 is configured to host an AI/ML module 107.

As discussed above, the GCM node 102 may receive one or more compute requests, and may output one or more responses. Each request is a function, and each response is a function that includes “reference IDs” for each output that has data populated. The request is a single function which may be primitive (does not decompose further) or a composite function that contains a sub-graph having the structure discussed above. For example, the request may be a composite function containing only a single primitive function, such as multiply, or it may contain both primitive and composite functions in its sub-graph. All the functions within the sub-graph, recursively, are in a total ordering following the directed edges of the graph, such as for each edge (a→b), the function containing a occurs prior to the function containing b in the ordering.

Sub-graph inputs and outputs are said to be occupied by dummy sub-graph functions representing the inputs and outputs of the sub-graph such that the dummy sub-graph input has output variables for each sub-graph input, and the dummy sub-graph output function has input variables for each sub-graph output. The GCM node 102 iterates through each operation (i.e., function) in the request (via their total ordering) and for each primitive, it checks that each input is supplied and runs all assertion functions. If all criteria are met, the function and related data is ingested into to the ML/AI module 107.

In one embodiment, differentiation functionality may be implemented as follow. The GCM node 102 may have a method for specifying another variable's vector in the same graph compute request function. The method can be one of many possible coordinate systems, such as a 1D vector of strings corresponding to the sequence of names of functions which are all composite except for possibly the last, followed by the name of a unique variable of the last function (this would represent a path from the root of the function to a specific primitive function's variable, because the root function is hierarchical).

Thus, the path in the DAG can be specified using the coordinate system by referring to both the start and end variables in the graph, where the path is between graph edges including function dependency edges. This enables the necessary components for a function whose method involves a derivative between other functions, such as a derivative of the vector produced at the end of the path with respect to the vector supplying the start of the path.

Upon receiving the initial request, the GCM node 102 scans the functions for function types involving coordinate systems. Then, the coordinate systems are used to locate the variable(s). If the function type is using the variables as part of a path or other graph element, then the graph element is calculated via GCM node 102 instructions that are coded based on the function type.

The request composer module may order these functions with coordinate systems (within the total order of the request) to occur after the functions containing those coordinated variables in the total order. This way, if the functions containing those located/coordinated variables run successfully, then data will supply those variables at the time the coordinate system locates them.

The result/outputs of the ML/AI module 107 are the function(s) where for each output of the function, either the output has a reference ID assigned corresponding with a result, or an error is assigned to the output. The reference ID is a reference to the database where the variable's data associated with the output is stored and retrieved. Each GCM node 102 response is the same function as the request it received except where the output variables are now assigned reference IDs for functions that were executed. Any time, the reference ID can be used to access pages of the data, or the entire data for that variable, via the data service module (not shown). As discussed above, reference IDs are also passed between edges (when edges are added, when the source of the edge has a reference ID assigned). The GCM node 102 may use the data service module to access the actual data during the compute.

For accessing sub-elements (i.e., pages of data representing a single reference ID), the data service module may use an extraction schema to determine how to extract sub-elements of the data. The GCM node 102 may also return any errors that occurred while executing a function that is included in a request. The errors include violations to an assertion, out-of-memory error, or a violation to the request format. The errors are then associated with the function and variables that caused the error occurrence.

In one embodiment, the ML/AI module 107 may execute the following exemplary steps.

The ML/AI module 107 may receive one or more functions.

The ML/AI module 107 may determine an optimization for running the function depending on memory allocation and hardware availability. Each function is treated independently.

For each reference ID occupying an input variable, the reference ID (and an authentication key from the graph compute request) is sent to the data service module to lookup the vector stored for the reference ID. The data service may have the vector cached already when the vector is recently written to, such as a vector of model parameters. The function is run using the input vectors according to pre-coded instructions specifying CPU directions and dynamic memory allocation for vector calculations on all data types. The function's instructions may involve reading and writing to specific data sources by delegating these instructions to the data service module using designated data service instructions to indicate the directions. For example, the function may itself be to submit the vector as a model parameter. This function, then, can generate the request to the data service. Elements of the request may be pre-generated by a previous step. The function may return “0” or more output parameters. Each output is either a scalar or vector that is the result of the execution, and can be of any data type such as integer, 4-bit floating point, 32-bit floating point, Boolean, string, etc.

The GCM node 102 may receive the ML/AI module 107 outputs which are sent to the data service module (not shown) to be assigned a reference ID for each output. This can be done on a separate thread so that GCM node 102 can continue. When the reference ID is returned, it is assigned to the corresponding output variable of the function. A systematic mapping such as a deterministic ordering of the outputs can be used to map the outputs (and reference IDs) to the variables.

The GCM node 102 may receive DAG data from a DAG source entity 101 that may be associated with a user 111 and intended for the developer entity nodes 113 (or the DAG source entity 101 may be a developer entity itself). In one embodiment, the received DAG data may be processed by the GCM node 102 using the pre-trained large language models (LLMs) to derive a language indicator and to parse out the data of the user 111 based on the language indicator metadata. In other words, the key features of the DAG may be derived from the DAG-related data based on the language of the DAG update request data.

The GCM node 102 may query a local graph database for the historical local DAGs' data 103 associated with the current DAG data. The GCM node 102 may acquire relevant remote DAGs' data 106 from a remote database residing on a cloud server 105 of a third-party DAG-based system(s). The remote DAG' data 106 may be collected from other DevOps facilities. The remote DAGs' data 106 may be collected from DAG source entities similar to the DAG source entity 101 based on, for example, DAG types, project types, IP addresses, language or locations, URLs, email addresses, etc. as the local DAGs' data 103 that is associated with the current DAG data.

The GCM node 102 may generate a feature vector or classifier based on the DAG data and the collected DAGs' data (i.e., pre-stored local data 103 and remote data 106). The features derived for the classifier may be indicative of DAG usage and requested/triggered DAG state changes.

The GCM node 102 may ingest the feature vector/classifier into an AI/ML module 107. The AI/ML module 107 may generate a predictive model(s) 108 based on the feature vector to predict DAG update parameters for automatically generating reference IDs linked to the DAG update variables to be provided to the developer entities 113 and/or to the DAG source entity. As discussed above, the DAG update parameters may be further analyzed by the GCM node 102 to map the reference IDs to the variables of the DAG being updated.

FIG. 1B illustrates a network diagram of a system for an automated real-time DAG management based on predictive analytics of DAG input-related data employing a blockchain consistent with the present disclosure.

Referring to FIG. 1B, the example network 100′ includes the Graph Compute Manager (GCM) node 102 connected to a cloud server node(s) 105 over a network. The GCM node 102 is configured to host an AI/ML module 107.

The GCM node 102 may receive the ML/AI module 107 outputs which are sent to the data service module (not shown) to be assigned a reference ID for each output. This can be done on a separate thread so that GCM node 102 can continue. When the reference ID is returned, it is assigned to the corresponding output variable of the function. A systematic mapping such as a deterministic ordering of the outputs can be used to map the outputs (and reference IDs) to the variables.

The GCM node 102 may receive DAG data from a DAG source entity 101 that may be associated with a user 111 and intended for the developer entity nodes 113 (or the DAG source entity 101 may be a developer entity itself). In one embodiment, the received DAG data may be processed by the GCM node 102 using the pre-trained large language models (LLMs) to derive a language indicator and to parse out the data of the user 111 based on the language indicator metadata. In other words, the key features of the DAG may be derived from the DAG-related data based on the language of the DAG update request data.

The GCM node 102 may query a local graph database for the historical local DAGs' data 103 associated with the current DAG data. The GCM node 102 may acquire relevant remote DAGs' data 106 from a remote database residing on a cloud server 105 of a third-party DAG-based system(s). The remote DAG' data 106 may be collected from other DevOps facilities. The remote DAGs' data 106 may be collected from DAG source entities similar to the DAG source entity 101 based on, for example, DAG types, project types, IP addresses, language or locations, URLs, email addresses, etc. as the local DAGs' data 103 that is associated with the current DAG data.

The GCM node 102 may generate a feature vector or classifier based on the DAG data and the collected DAGs' data (i.e., pre-stored local data 103 and remote data 106). The features derived for the classifier may be indicative of DAG usage and requested/triggered DAG state changes.

The GCM node 102 may ingest the feature vector/classifier into an AI/ML module 107. The AI/ML module 107 may generate a predictive model(s) 108 based on the feature vector to predict DAG update parameters for automatically generating reference IDs linked to the DAG update variables to be provided to the developer entities 113 and/or to the DAG source entity. As discussed above, the DAG update parameters may be further analyzed by the GCM node 102 to map the reference IDs to the variables of the DAG being updated.

The AI/ML module 107 may generate a predictive model(s) 108 to predict the DAG update parameters in response to the specific relevant pre-stored DAGs'-related data acquired from the blockchain 110 ledger 109. This way, the current DAG update parameters may be predicted based not only on the current DAG-related data, but also based on the previously collected heuristics and DAGs'-related data associated with the given DAG data and the current DAG update parameters derived from the DAG data. This way, the most optimal way of handling the DAG management and system orchestration may be employed and recorded on the blockchain 110 ledger 109 for future references.

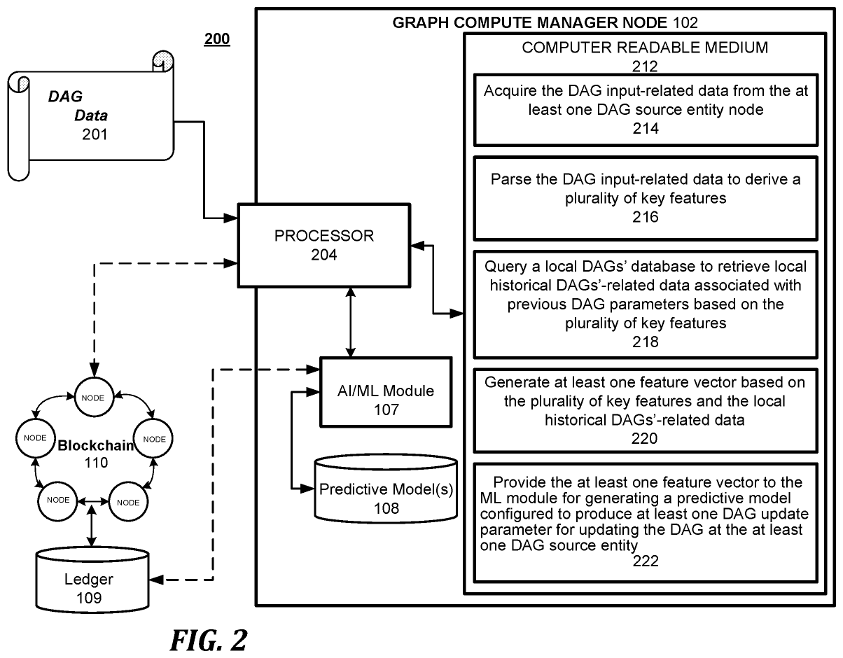

FIG. 2 illustrates a network diagram of a system including detailed features of a graph compute manager (GCM) node consistent with the present disclosure.

Referring to FIG. 2, the example network 200 includes the GCM node 102 connected to the DAG source entity 101 (see FIG. 1A) to receive DAG data 201. The GCM node 102 is configured to host an AI/ML module 107. As discussed above with respect to FIGS. 1A-B, the GCM node 102 may receive the DAG data provided by the DAG source entity 101 (FIG. 1A) and pre-stored DAGs' data retrieved from local and remote third-party databases. As discussed above, the pre-stored DAGs' data may be retrieved from the ledger 109 of the blockchain 110.

The AI/ML module 107 may generate a predictive model(s) 108 based on the received DAG data 201 provided by the GCM node 102. In one embodiment, the incoming DAG data may be normalized and standardized by a data normalization engine (not shown). As discussed above, the AI/ML module 107 may provide predictive outputs data in the form of DAG update parameters for automatic generation or retrieval of the DAG update variables. The GCM node 102 may process the predictive outputs data received from the AI/ML module 107 to ultimately generate the DAG update/state change. In one embodiment, the GCM node 102 may acquire DAG data from the DAG source entity(s) continuously or periodically in order to check if new DAG update recommendations need to be generated. In another embodiment, the GCM node 102 may continually monitor DAG-related data and may detect a DAG parameter/variable that deviates from a previously recorded DAG parameter (or from a median reading value) by a margin that exceeds a threshold value pre-set for this particular DAG parameter. Accordingly, once the threshold is met or exceeded by at least one DAG parameter, the GCM node 102 may provide the currently acquired DAG parameter to the AI/ML module 107 to generate a list of updated DAG update parameters based on the current DAG classifications and updated request requirements.

While this example describes in detail only one GCM node 102, multiple such nodes may be connected to the network and to the blockchain 110. It should be understood that the GCM node 102 may include additional components and that some of the components described herein may be removed and/or modified without departing from a scope of the BOS node 102 disclosed herein. The GCM node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the BOS node 102 may include multiple processors, multiple cores, or the like, without departing from the scope of the GCM node 102 system.

The GCM node 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire the DAG input-related data from the at least one DAG source entity node. The processor 204 may fetch, decode, and execute the machine-readable instructions 216 parse the DAG input-related data to derive a plurality of key features. The processor 204 may fetch, decode, and execute the machine-readable instructions 218 to query a local DAGs' database to retrieve local historical DAGs'-related data associated with previous DAG parameters based on the plurality of key features. The processor 204 may fetch, decode, and execute the machine-readable instructions 220 to generate at least one feature vector based on the plurality of key features and the local historical DAGs'-related data.

The processor 204 may fetch, decode, and execute the machine-readable instructions 222 to provide the at least one feature vector to the ML module for generating a predictive model configured to produce at least one DAG update parameter for updating the DAG at the at least one DAG source entity.

The permissioned blockchain 110 may be configured to use one or more smart contracts that manage transactions for multiple participating nodes and for recording the transactions on the ledger 109. As discussed above, the GCM node 102 system prioritizes using its own heuristic data 103 from local DBs. This ensures a faster, more tailored response to the DAG updates. Local datasets may be recorded on a private (permissioned) blockchain 110. This provides a tamper-evident log of identified DAG state updates, enhancing security and transparency. The blockchain log may also contain a trail of how the ML models 108 have been trained and evolved over time, which offers an auditable history of model adjustments and training.

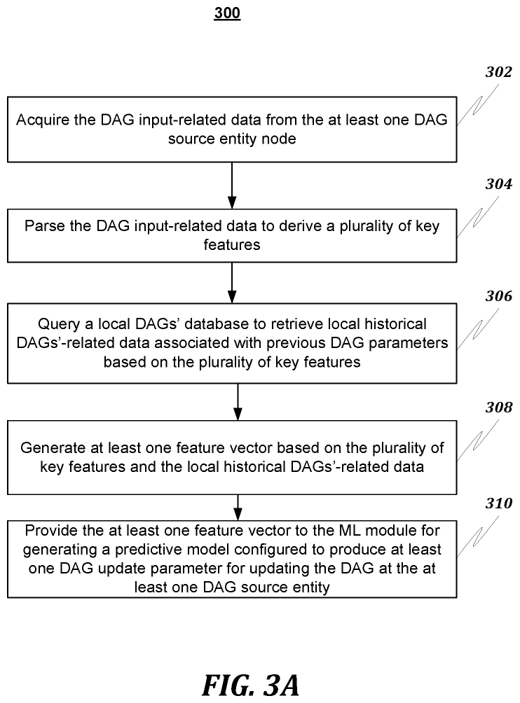

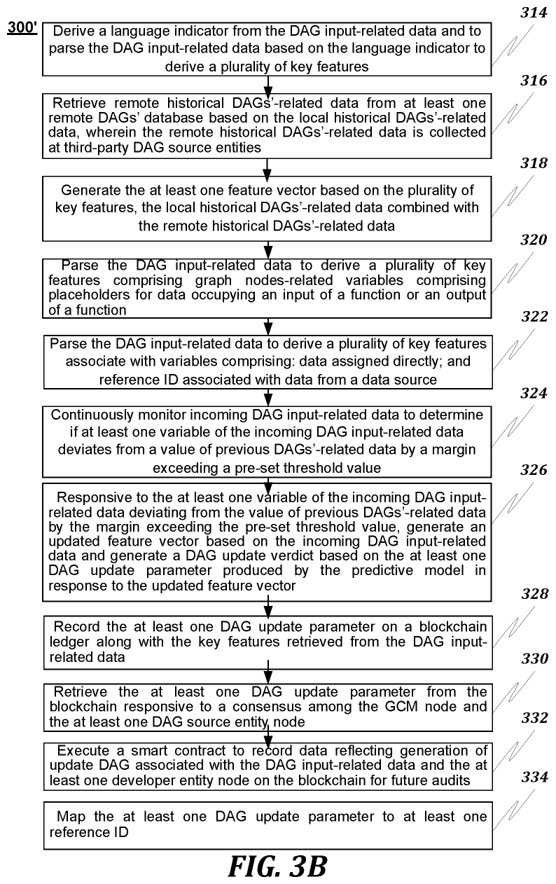

FIG. 3A illustrates a flowchart of a method for an automated real-time DAG management based on predictive analytics of DAG input-related data consistent with the present disclosure.

Referring to FIG. 3A, the method 300 may include one or more of the steps described below. FIG. 3A illustrates a flow chart of an example method executed by the GCM node 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the GCM node 102 may execute some or all of the operations included in the method 300.

With reference to FIG. 3A, at block 302, the processor 204 may acquire the DAG input-related data from the at least one DAG source entity node. At block 304, the processor 204 may parse the DAG input-related data to derive a plurality of key features. At block 306, the processor 204 may query a local DAGs' database to retrieve local historical DAGs'-related data associated with previous DAG parameters based on the plurality of key features. At block 308, the processor 204 may generate at least one feature vector based on the plurality of key features and the local historical DAGs'-related data. At block 310, the processor 204 may provide the at least one feature vector to the ML module for generating a predictive model configured to produce at least one DAG update parameter for updating the DAG at the at least one DAG source entity.

FIG. 3B illustrates a further flowchart of a method for an automated real-time DAG management based on predictive analytics of DAG input-related data consistent with the present disclosure.

Referring to FIG. 3B, the method 300′ may include one or more of the steps described below. FIG. 3B illustrates a flow chart of an example method executed by the GCM node 102 (see FIG. 2). It should be understood that method 300′ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the GCM node 102 may execute some or all of the operations included in the method 300′.

With reference to FIG. 3B, at block 314, the processor 204 may derive a language indicator from the DAG input-related data and to parse the DAG input-related data based on the language indicator to derive a plurality of key features. At block 316, the processor 204 may retrieve remote historical DAGs'-related data from at least one remote DAGs' database based on the local historical DAGs'-related data, wherein the remote historical DAGs'-related data is collected at third-party DAG source entities.

At block 318, the processor 204 may generate the at least one feature vector based on the plurality of key features, the local historical DAGs'-related data combined with the remote historical DAGs'-related data. At block 320, the processor 204 may parse the DAG input-related data to derive a plurality of key features comprising graph nodes-related variables comprising placeholders for data occupying an input of a function or an output of a function.

At block 322, the processor 204 may parse the DAG input-related data to derive a plurality of key features associate with variables including data assigned directly and reference ID associated with data from a data source. At block 324, the processor 204 may continuously monitor incoming DAG input-related data to determine if at least one variable of the incoming DAG input-related data deviates from a value of previous DAGs'-related data by a margin exceeding a pre-set threshold value. At block 326, the processor 204 may, responsive to the at least one variable of the incoming DAG input-related data deviating from the value of previous DAGs'-related data by the margin exceeding the pre-set threshold value, generate an updated feature vector based on the incoming DAG input-related data and generate a DAG update verdict based on the at least one DAG update parameter produced by the predictive model in response to the updated feature vector. At block 328, the processor 204 may record the at least one DAG update parameter on a blockchain ledger along with the key features retrieved from the DAG input-related data.

At block 330, the processor 204 may retrieve the at least one DAG update parameter from the blockchain responsive to a consensus among the GCM node and the at least one DAG source entity node. At block 332, the processor 204 may execute a smart contract to record data reflecting generation of update DAG associated with the DAG input-related data and the at least one developer entity node on the blockchain for future audits. At block 334, the processor 204 may map the at least one DAG update parameter to at least one reference ID.

In one disclosed embodiment, the DAG update (or orchestration) parameters' model may be generated by the AI/ML module 107 that may use training data sets to improve accuracy of the prediction of the DAG update parameters for the developer entities 113 (FIG. 1A). The DAG update parameters used in training data sets may be stored in a centralized local database (such as one used for storing local DAG' data 103 depicted in FIG. 1A). In one embodiment, a neural network may be used in the AI/ML module 107 for the DAG update parameters modeling and DAG update predictions.

In another embodiment, the AI/ML module 107 may use a decentralized storage such as a blockchain 110 (see FIG. 1B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 113 and 102 (FIG. 1B) may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as storing lead response parameters for efficient handling of leads, but which do not fully trust one another.

This application utilizes a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

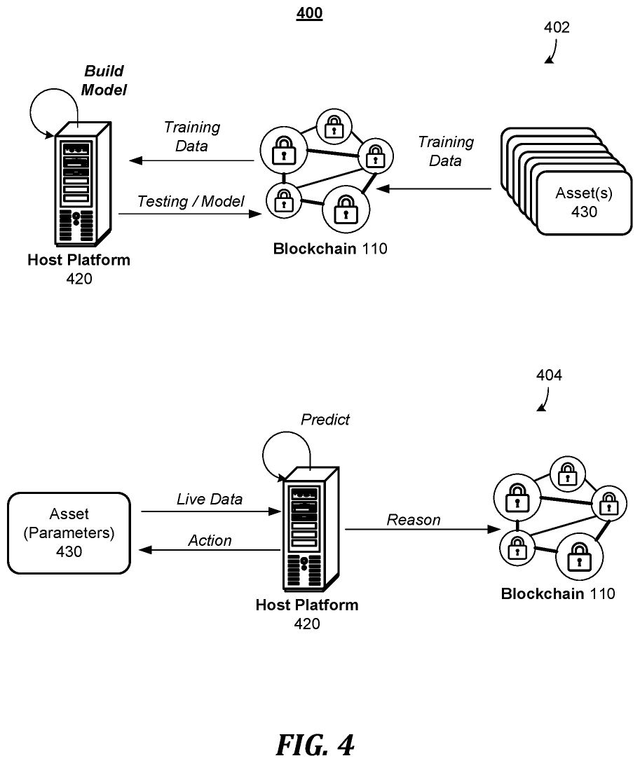

In the example depicted in FIG. 4, a host platform 420 (such as the GCM node 102) builds and deploys a machine learning model for predictive monitoring of assets 430. Here, the host platform 420 may be a cloud platform, an industrial server, a web server, a personal computer, a user device, and the like. Assets 430 can represent DAG-related parameters. The blockchain 110 can be used to significantly improve both a training process 402 of the machine learning model and the DAF update parameters' predictive process 405 based on a trained machine learning model. For example, in 402, rather than requiring a data scientist/engineer or other user to collect the data, historical data (heuristics—i.e., DAGs'-related data) may be stored by the assets 430 themselves (or through an intermediary, not shown) on the blockchain 110.

This can significantly reduce the collection time needed by the host platform 420 when performing predictive model training. For example, using smart contracts, data can be directly and reliably transferred straight from its place of origin (e.g., from the GCM node 102 or from DAGs' databases 103 and 106 in FIGS. 1A-1B) to the blockchain 110. By using the blockchain 110 to ensure the security and ownership of the collected data, smart contracts may directly send the data from the assets to the entities that use the data for building a machine learning model. This allows for sharing of data among the assets 430. The collected data may be stored in the blockchain 110 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and testing by the host platform 420. Each round may be based on additional data or data that was not previously considered to help expand the knowledge of the machine learning model. In 402, the different training and testing steps (and the data associated therewith) may be stored on the blockchain 110 by the host platform 420. Each refinement of the machine learning model (e.g., changes in variables, weights, etc.) may be stored on the blockchain 110. This provides verifiable proof of how the model was trained and what data was used to train the model. Furthermore, when the host platform 420 has achieved a finally trained model, the resulting model itself may be stored on the blockchain 110.

After the model has been trained, it may be deployed to a live environment where it can make DAG update-related predictions/decisions based on the execution of the final trained machine learning model using the DAG update parameters. In this example, data fed back from the asset 430 may be input into the machine learning model and may be used to make event predictions such as most accurate DAG state change parameters. Determinations made by the execution of the machine learning model (e.g., verdicts or recommendations or DAG orchestration parameters, etc.) at the host platform 420 may be stored on the blockchain 110 to provide auditable/verifiable proof. As one non-limiting example, the machine learning model may predict a future change of a part of the asset 430 (the DAG update parameters). The data behind this decision may be stored by the host platform 420 on the blockchain 110.

As discussed above, in one embodiment, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

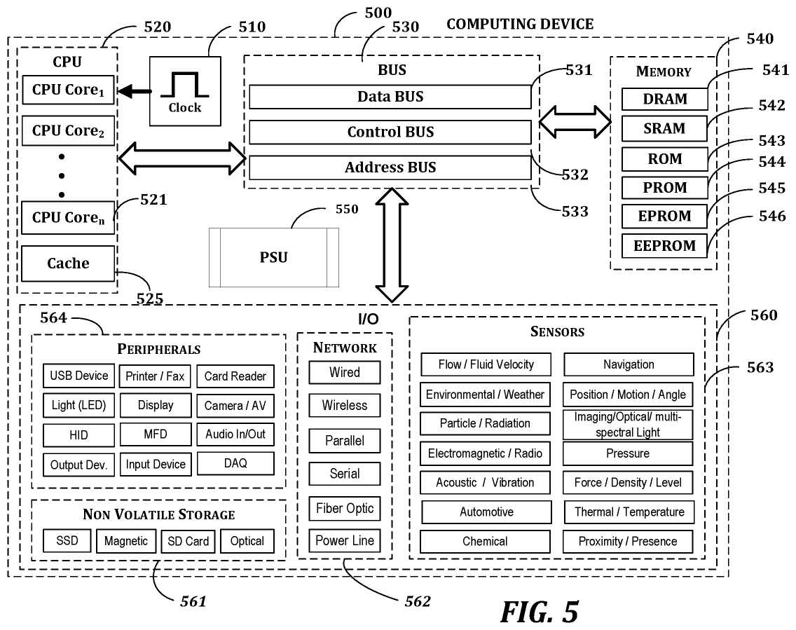

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

FIG. 5 illustrates a block diagram of a system including computing device 500. The computing device 500 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
The GCM node 102 (see FIG. 2) may be hosted on a centralized server or on a cloud computing service. Although method 300 has been described to be performed by the GCM node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the GCM node 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/0 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of the clock 510 may include dynamic frequency change, where the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).

### Music Instrument Digital Interface (MIDI)

Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, known to the person having ordinary skill in the art as primary storage or memory 550. The memory 550 operates at high speed, distinguishing it from the non-volatile storage sub-module 561, which may be referred to as secondary or tertiary storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also other purposes in the computing device 500. The memory 550 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/0 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 550. The non-volatile storage sub-module 561 does not lose data when power is removed and may be two orders of magnitude less costly than storage used in memory modules, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G,5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices used to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system for an automated real-time management of a directed acyclic graph (DAG) based on predictive analytics of DAG input-related data, comprising:
a processor of a graph compute manager (GCM) node configured to host a machine learning (ML) module and connected to at least one DAG source entity node over a network; and
a memory on which are stored machine-readable instructions that when executed by the processor, cause the processor to:
acquire the DAG input-related data from the at least one DAG source entity node;
parse the DAG input-related data to derive a plurality of key features;
query a local DAGs' database to retrieve local historical DAGs'-related data associated with previous DAG parameters based on the plurality of key features;
generate at least one feature vector based on the plurality of key features and the local historical DAGs'-related data; and
provide the at least one feature vector to the ML module for generating a predictive model configured to produce at least one DAG update parameter for updating the DAG at the at least one DAG source entity.

2. The system of claim 1, wherein the instructions further cause the processor to derive a language indicator from the DAG input-related data and to parse the DAG input-related data based on the language indicator to derive a plurality of key features.

3. The system of claim 1, wherein the instructions further cause the processor to retrieve remote historical DAGs'-related data from at least one remote DAGs' database based on the local historical DAGs'-related data, wherein the remote historical DAGs'-related data is collected at third-party DAG source entities.

4. The system of claim 3, wherein the instructions further cause the processor to generate the at least one feature vector based on the plurality of key features, the local historical DAGs'-related data combined with the remote historical DAGs'-related data.

5. The system of claim 1, wherein the instructions further cause the processor to parse the DAG input-related data to derive a plurality of key features comprising graph nodes-related variables comprising placeholders for data occupying an input of a function or an output of a function.

6. The system of claim 1, wherein the instructions further cause the processor to parse the DAG input-related data to derive a plurality of key features associate with variables comprising:
data assigned directly;
reference ID associated with data from a data source.

7. The system of claim 1, wherein the instructions further cause the processor to continuously monitor incoming DAG input-related data to determine if at least one variable of the incoming DAG input-related data deviates from a value of previous DAGs'-related data by a margin exceeding a pre-set threshold value.

8. The system of claim 7, wherein the instructions further cause the processor to, responsive to the at least one variable of the incoming DAG input-related data deviating from the value of previous DAGs'-related data by the margin exceeding the pre-set threshold value, generate an updated feature vector based on the incoming DAG input-related data and generate a DAG update verdict based on the at least one DAG update parameter produced by the predictive model in response to the updated feature vector.

9. The system of claim 1, wherein the instructions further cause the processor to record the at least one DAG update parameter on a blockchain ledger along with the key features retrieved from the DAG input-related data.

10. The system of claim 9, wherein the instructions further cause the processor to retrieve the at least one DAG update parameter from the blockchain responsive to a consensus among the GCM node and the at least one DAG source entity node.

11. The system of claim 9, wherein the instructions further cause the processor to execute a smart contract to record data reflecting generation of update DAG associated with the DAG input-related data and the at least one developer entity node on the blockchain for future audits.

12. The system of claim 1, wherein the instructions further cause the processor to map the at least one DAG update parameter to at least one reference ID.

13. A method for an automated real-time management of a directed acyclic graph (DAG) based on predictive analytics of DAG input-related data, comprising:
acquiring, by a graph compute manager (GCM) node, the DAG input-related data from at least one DAG source entity node;
parsing, by the GCM node, the DAG input-related data to derive a plurality of key features;
querying, by the GCM node, a local DAGs' database to retrieve local historical DAGs'-related data associated with previous DAG parameters based on the plurality of key features;
generating, by the GCM node, at least one feature vector based on the plurality of key features and the local historical DAGs'-related data; and
providing, by the GCM node, the at least one feature vector to the ML module for generating a predictive model configured to produce at least one DAG update parameter for updating the DAG at the at least one DAG source entity.

14. The method of claim 13, further comprising parsing the DAG input-related data to derive a plurality of key features associate with variables comprising:
data assigned directly;
reference ID associated with data from a data source.

15. The method of claim 13, further comprising continuously monitoring incoming DAG input-related data to determine if at least one variable of the incoming DAG input-related data deviates from a value of previous DAGs'-related data by a margin exceeding a pre-set threshold value.

16. The method of claim 15, further comprising, responsive to the at least one variable of the incoming DAG input-related data deviating from the value of previous DAGs'-related data by the margin exceeding the pre-set threshold value, generating an updated feature vector based on the incoming DAG input-related data and generate a DAG update verdict based on the at least one DAG update parameter produced by the predictive model in response to the updated feature vector.

17. The method of claim 13, further comprising recording the at least one DAG update parameter on a blockchain ledger along with the key features retrieved from the DAG input-related data.

18. The method of claim 14, further comprising mapping the at least one DAG update parameter to at least one reference ID.

19. A non-transitory computer-readable medium comprising instructions, that when read by a processor, cause the processor to perform:
acquiring directed acyclic graph (DAG) input-related data from at least one DAG source entity node;
parsing the DAG input-related data to derive a plurality of key features;
querying a local DAGs' database to retrieve local historical DAGs'-related data associated with previous DAG parameters based on the plurality of key features;
generating at least one feature vector based on the plurality of key features and the local historical DAGs'-related data; and
providing the at least one feature vector to the ML module for generating a predictive model configured to produce at least one DAG update parameter for updating the DAG at the at least one DAG source entity.

20. The non-transitory computer readable medium of claim 19, further comprising parsing the DAG input-related data to derive a plurality of key features associate with variables comprising reference ID associated with data from a data source and mapping the at least one DAG update parameter to the reference ID.
